(19) United States
(12) Patent Application Publication
(10) Pub. No.: US 2008/0231016 A1
(43) Pub. Date: Sep. 25, 2008

(54) TRAILER COMBINED WITH A MOVABLE WHEEL ASSEMBLY

(76) Inventor: GEORGE WALL, MANCHESTER, IA (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 11/688,606

(22) Filed: Mar. 20, 2007

(51) Int. Cl. B60P 1/04

(52) U.S. Cl. 280/405.1

(57) ABSTRACT

A trailer combined with a movable wheel assembly. The trailer comprises a front portion and a load carrying bed portion. The front portion is combined with the load carrying bed portion at a pivot point so that the front portion and load carrying bed portion can pivot relative to each other. A rack and pinion means allows selective movement of the wheel assembly relative to the trailer. The rack is combined with the load carrying bed portion of the trailer, and the pinion is combined with the movable wheel assembly. A power assist means, such as a hydraulic motor, is combined with the movable wheel assembly and is adapted to rotate the pinion. Activation of the power assist means rotates the pinion and moves the wheel assembly in a first direction along the rack towards the front of the load carrying bed or in a second direction along the rack towards the rear of the load carrying bed. As the wheel assembly is moved toward the front of the load carrying bed, the rear end of the load carrying bed can be lowered to the ground to act as a ramp to allow objects to be loaded or unloaded from the trailer.

### BACKGROUND OF THE INVENTION

The present invention relates to transport truck trailers and more particularly to a slidable mounting assembly for the rear wheels thereof.

It is often desirable to tow or transport large objects such as buses, tractors, or other large machinery on a flatbed trailer. However, loading and unloading these objects on and off of the flatbed trailer can be difficult. In order to ease the loading and unloading of these large objects, flatbed trailers have been developed that tilt the entire bed of the trailer thereby providing a ramp with a relatively gradual incline. In order to present an optimum loading angle as well as to evenly distribute the load carried by the trailer, it has been found desirable to mount the wheels for such trailers in a manner permitting selective fore and aft shifting movement of the wheels relative to the trailer's load carrying bed. By this arrangement, the wheels may be shifted forwardly on the bed to permit tilting of the bed to a desired gradual loading angle, while the wheels may be shifted rearwardly after loading of the bed to provide even weight distribution of the load between the trailer wheels and the wheels of the prime mover vehicle.

An example of the type of trailer described in the previous paragraph is disclosed in U.S. Pat. No. 4,231,710 (Landoll). The trailer disclosed in Landoll comprises a single, relatively long, hydraulic cylinder beneath the bed of the trailer for shifting the wheel assembly forwardly from its normally rearmost roading position to a position permitting tilting of the bed, thereby bringing the rear end of the inclined bed close to the ground. One problem with the device disclosed in Landoll is that it cannot move the wheel assembly the entire length of the trailer because the hydraulic cylinder is too short. Lengthening the cylinder is not an option because this would create many unacceptable problems such as cylinder vibration during over-the-road travel, breakage and inadequate power for shifting the undercarriage, especially when considering the heaviness of many kinds of cargo on the bed. Another problem with the device disclosed in Landoll is that it takes a lot of power to actuate the large hydraulic cylinder. Yet another problem with the device disclosed in Landoll is that the cylinder is expensive to manufacture and maintain due to its relatively large size and weight.

Therefore, there is a need for a trailer having a movable wheel assembly that is capable of extending along generally the entire length of the trailer bed. There is further a need for a trailer having a moveable wheel assembly that is simple to maintain and efficient to operate.

### SUMMARY OF THE INVENTION

The present invention comprises a trailer combined with a movable wheel assembly. The trailer comprises a front portion and a load carrying bed portion. The front portion is adapted to be combined with a prime mover vehicle. The front portion is combined with the load carrying bed portion at a pivot point so that the front portion and load carrying bed portion can pivot relative to each other. The load carrying bed portion of the trailer further comprises a front end and a rear end.

A rack and pinion means allows selective movement of the wheel assembly relative to the trailer. The rack is combined with the load carrying bed portion of the trailer, and the pinion is combined with the movable wheel assembly. A power assist means, such as a hydraulic motor, is combined with the movable wheel assembly and is adapted to rotate the pinion. Activation of the power assist means rotates the pinion and moves the wheel assembly in a first direction along the rack towards the front of the load carrying bed or in a second direction along the rack towards the rear of the load carrying bed.

As the wheel assembly is moved toward the front of the load carrying bed, the rear end of the load carrying bed can be lowered to the ground. This is accomplished by the actuation of a power assist means, such as a hydraulic lift cylinder. The lift cylinder comprises a first end and a second end. The first end of the lift cylinder is combined with the front portion of the trailer and the second end of the lift cylinder is combined with the load carrying bed portion of the trailer. Actuation of the lift cylinder causes the load carrying bed to pivot relative to the front portion of the trailer so that the rear end of the load carrying bed can be raised or lowered relative to the ground.

The invention is beneficial over existing slide axle trailers because the rack and pinion means powered by the hydraulic motor allows the wheel assembly to move generally the entire length of the load carrying bed. Further, the rack and pinion means powered by the hydraulic motor is a simpler and more cost effective design than the large hydraulic cylinders employed to move wheel assemblies on prior art slide axle trailers.

### BRIEF DESCRIPTION OF THE DRAWING

FIG. 1 is a side view of an embodiment of the present invention showing a trailer comprising a movable wheel assembly in its transport position;

FIG. 2 is a bottom view of an embodiment of the present invention showing the rack extending generally the entire length of the load carrying bed;

FIG. 3 is a side view of an embodiment of the present invention showing a trailer comprising a movable wheel assembly in its forward position;

FIG. 4 is a side view of an embodiment of the present invention showing a trailer comprising a movable wheel assembly in its load main deck position;

FIG. 5 is a side view of an embodiment of the present invention showing a trailer comprising a movable wheel assembly in its load upper deck position;

FIG. 6 is a side view of an embodiment of the present invention showing a trailer comprising a movable wheel assembly in its unload position;

FIG. 7 is a top view showing the rack and pinion assembly;

FIG. 8 is a side view showing the rack and pinion assembly;

FIG. 9 is a top view of an embodiment of a wheel assembly; and

FIG. 10 is a rear view of an embodiment of a wheel assembly showing the upper deck retaining roller and main deck transfer roller.

### DETAILED DESCRIPTION OF THE INVENTION

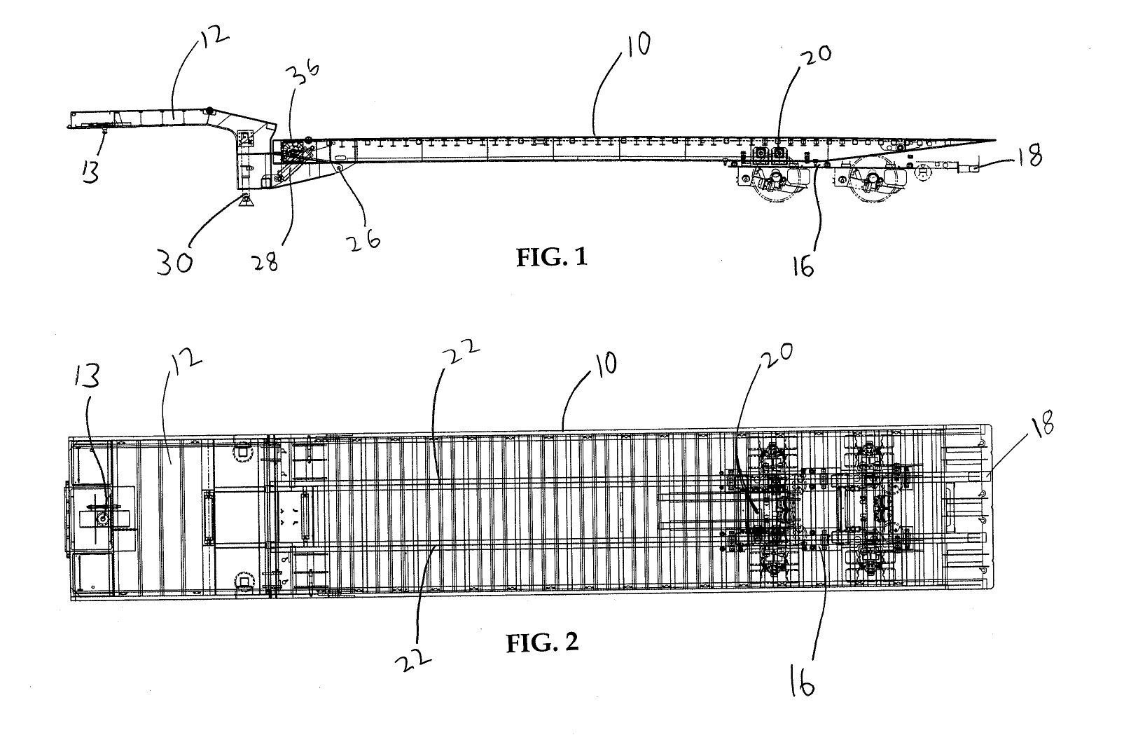

As seen in FIG. 1, the present invention comprises a trailer combined with a movable wheel assembly 16. The trailer comprises a front portion 12 and a load carrying bed portion 10. The front portion 12 is adapted to be combined with a prime mover vehicle by any suitable means. Preferably, the front portion 12 comprises a hitch 13 that is adapted to combine with a prime mover vehicle. The front portion 12 is combined with the load carrying bed 10 at a pivot point 26 so that the front portion 12 and load carrying bed 10 can pivot relative to each other. The load carrying bed 10 of the trailer further comprises a front end, a rear end, and a frame 11.

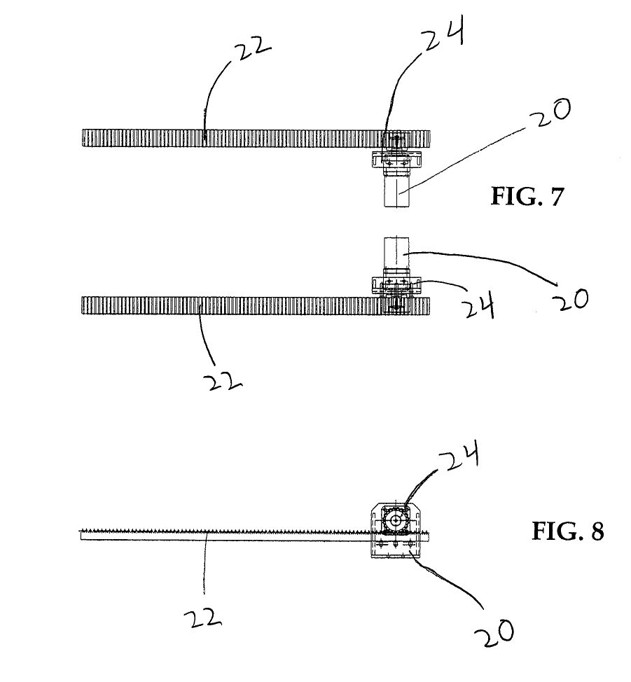

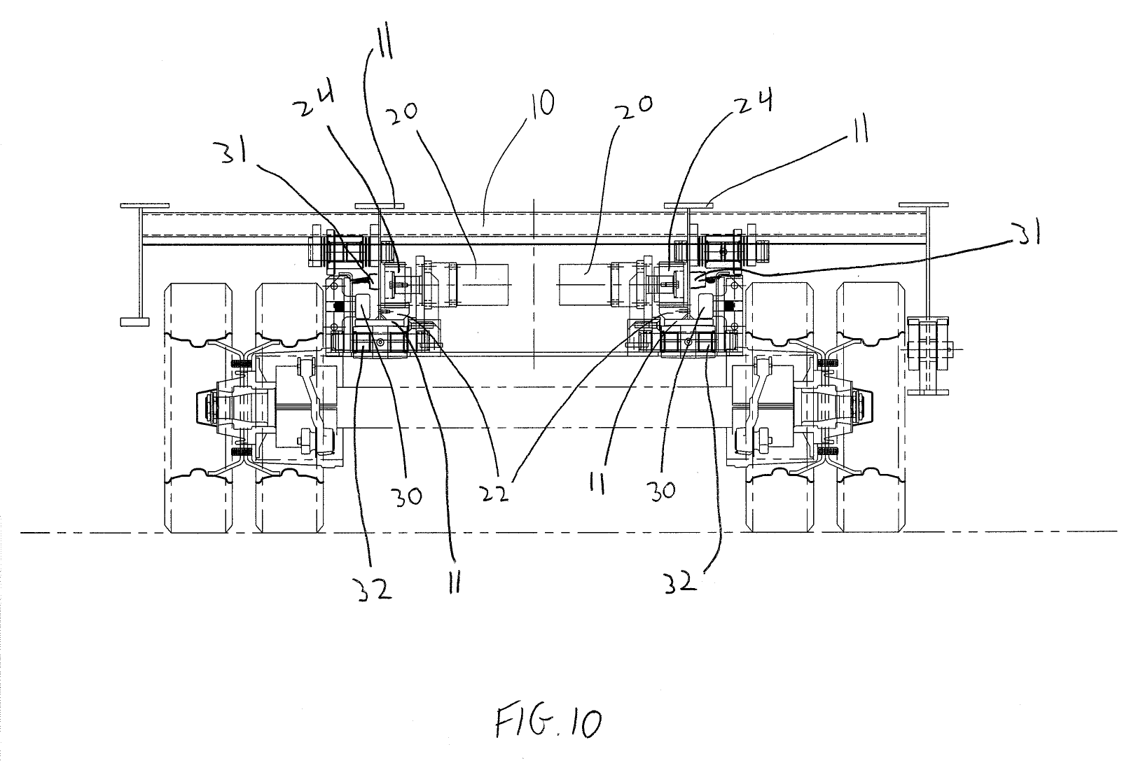

As seen best in FIGS. 2, 7, 8, and 10 a rack and pinion means allows selective movement of the wheel assembly 16 relative to the trailer. The rack 22 is combined with the load carrying bed 10 of the trailer and the pinion 24 (or other suitable gear) is combined with the movable wheel assembly 16. As seen in FIG. 10, in one embodiment the rack 22 is combined with the frame 11 of the load carrying bed 10 with its grooves facing upward. This helps to secure the wheel assembly 16 to the load carrying bed 10 because if the trailer is lifted off of the ground, the rack 22 supports the weight of the wheel assembly 16 and keeps the pinion 24 engaged with the rack 22.

A power assist means, such as a hydraulic motor 20, is combined with the movable wheel assembly 16 and is adapted to rotate the pinion 24. Activation of the hydraulic motor 20 in a first direction causes the pinion 24 to rotate in a first direction which moves the wheel assembly 16 along the rack 22 towards the front of the load carrying bed 10. Activation of the hydraulic motor 20 in a second direction causes the pinion 24 to rotate in a second direction which moves the wheel assembly 16 along the rack 22 towards the rear of the load carrying bed 10.

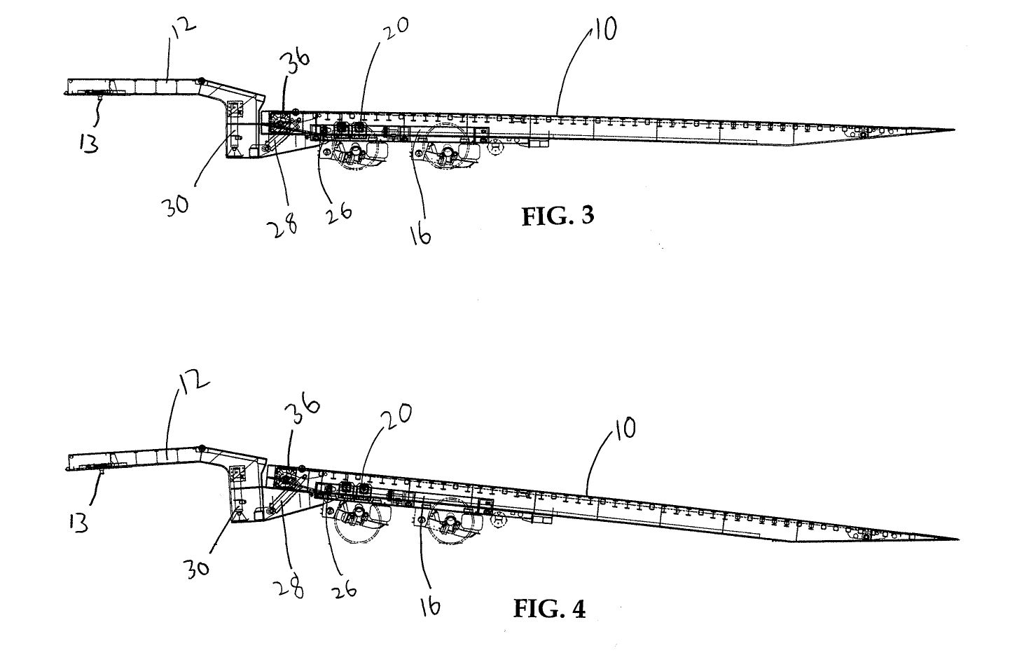

FIG. 1 shows the trailer with the movable wheel assembly 16 in its transport position toward the rear of the load carrying bed 10. As the wheel assembly 16 is moved toward the front of the load carrying bed 10 as shown in FIG. 3, the rear end of the load carrying bed 10 can be lowered to the ground as seen in FIGS. 4-6. This is accomplished by the actuation of a power assist means, such as a hydraulic lift cylinder 28. The lift cylinder 28 comprises a first end and a second end. The first end of the lift cylinder 28 is combined with the front portion 12 of the trailer and the second end of the lift cylinder 28 is combined with the load carrying bed 10 portion of the trailer. Actuation of the lift cylinder 28 causes the load carrying bed 10 to pivot relative to the front portion 12 of the trailer at the pivot point 26 so that the rear end of the load carrying bed 10 is pivoted toward to the ground. To move the wheel assembly 16 back to its transport position, the entire process is reversed.

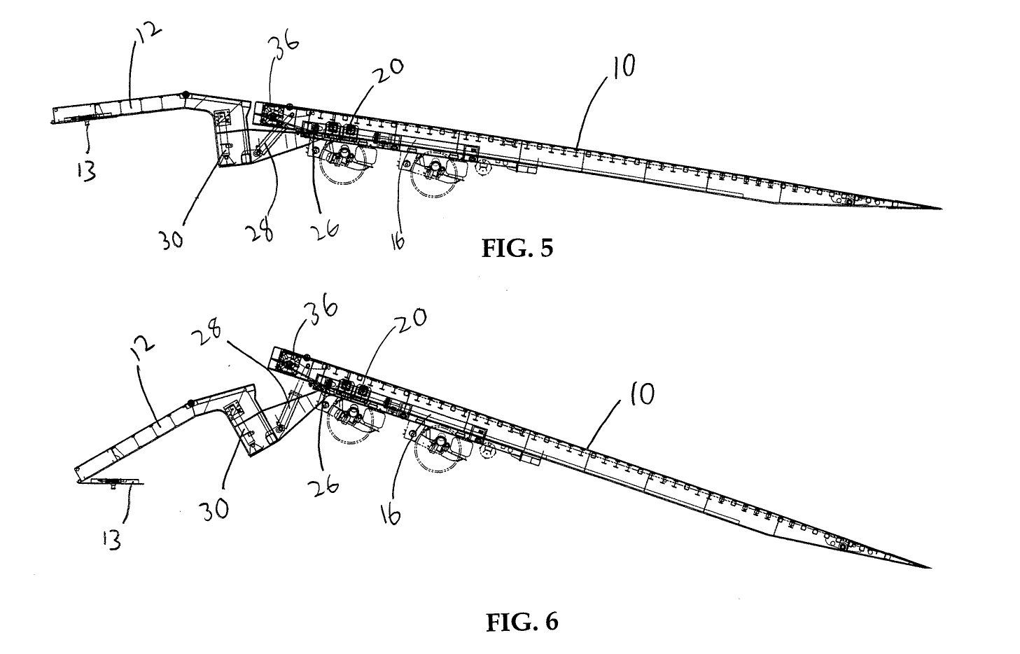

As noted above, FIGS. 4-6 show the invention in some of its load/unload positions. FIG. 4 shows the trailer with the load carrying bed 10 lowered to the ground by the lift cylinder 28. In this position, the load carrying bed 10 acts as a ramp to assist objects in being loaded onto or unloaded from the load carrying bed 10. FIG. 5 shows the lift cylinder 28 extended further to assist objects in being loaded onto or unloaded from the front 12 (upper) portion of the trailer. FIG. 6 shows the lift cylinder 28 extended still further to aid in unloading objects from the trailer. As shown in FIG. 6, the hitch 13 may be pivotally mounted to the trailer front portion 12 so that the trailer can achieve the position shown in FIG. 6 without becoming detached from the prime mover vehicle.

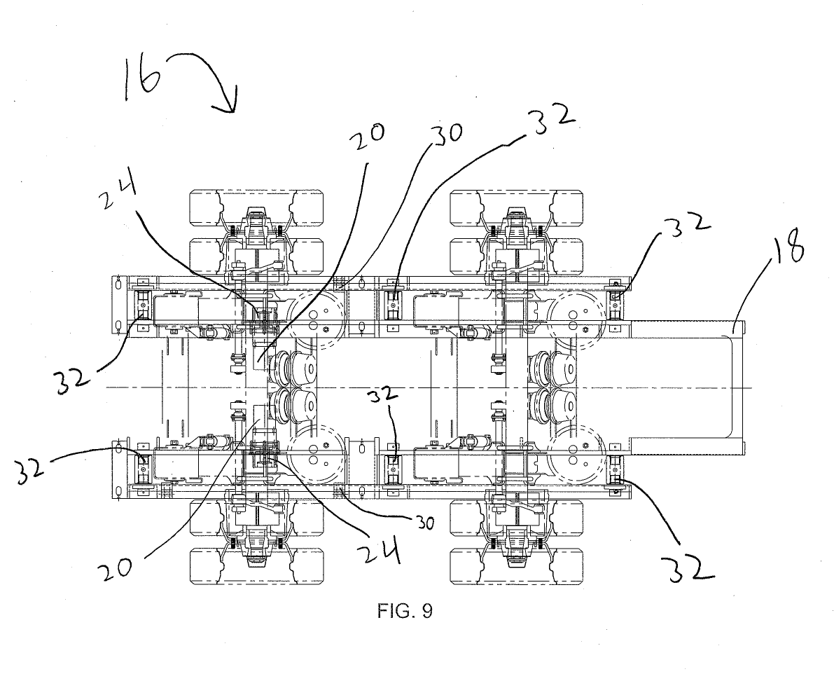

As seen best in FIGS. 9 and 10, some embodiments of the invention comprise upper deck retaining rollers 30, a bumper 18, and main deck transfer rollers 32. The upper deck retaining rollers 30 aid in combining the wheel assembly 16 to the load carrying bed 10 when the wheel assembly 16 is lifted off of the ground by preventing the wheel assembly 16 from separating from the load carrying bed 10. The upper deck retaining rollers 30 are combined with the wheel assembly 16 and are adapted to pivot about a central axis. The retaining rollers 30 are best seen in FIG. 10 where they engage a horizontal surface of the frame 11 of the bed 10. As can be imagined, when the trailer is lifted off of the ground, the retaining rollers 30 are supported by frame 11. In some embodiments, there are also linear guide rollers 31 similar to the rollers 30 but that engage a vertical surface of the frame 11 to help the wheel assembly 16 stay aligned with the bed 10/frame 11 as the assembly 16 is moved along the length of the bed 10/frame 11.

The bumper 18 is located near the rear of the load carrying bed 10 and provides a stop point that prevents the wheel assembly 16 from sliding too far backward off of the end of the rack 22. The main deck transfer rollers 32 aid in supporting the weight of the load carrying bed 10 as the wheel assembly 16 is moved under the load carrying bed 10. The main deck transfer rollers 32 are combined with the wheel assembly 16 and are adapted to pivot about a central axis. The rollers 32 engage the load carrying bed 10 as the wheel assembly 16 is moved along the length of the bed 10 to help support the weight of the bed 10 and to help the wheel assembly 16 move smoothly in relation to the bed 10.

In some embodiments, the trailer comprises a winch 36, as seen in FIG. 1. The winch 36 is preferably combined with the front of the trailer (either near the front of the load carrying bed 10 or on the trailer front portion 12.) The winch 36 can be powered by any suitable means, including hydraulically, eclectically, and manually. The winch 36 comprises a rope, chain, or other suitable connecting means that extends from the winch 36 and is adapted to be attached to an object. Actuating the winch 36 retracts the connecting means to aid in pulling the object onto the trailer or lowering the object off of the trailer.

As seen best in FIG. 1, some embodiments of the trailer comprise landing gear 30. The landing gear 30 is preferably a hydraulic, electric, or manual jack combined with either the front portion 12 of the trailer or the front end of the load carrying bed 10. The landing gear 30 supports the weight of the trailer when it is not combined with a prime mover vehicle.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is as follows:

1. A trailer comprising:
a front portion;
a load carrying bed pivotally combined with the front portion;
a wheel assembly combined with the underside of the load carrying bed;
a rack combined with the load carrying bed;
a pinion combined with the wheel assembly and adapted to engage the rack;
a power assist mechanism combined with the wheel assembly and adapted to rotate the pinion;
wherein activation of the power assist mechanism rotates the pinion and moves the wheel assembly along the rack.

2. The trailer of claim 1 further comprising a lift assist mechanism having a first end combined with the trailer front portion and a second end combined with the load carrying bed, wherein actuation of the lift assist mechanism pivots the trailer front portion relative to the load carrying bed.

3. The trailer of claim 2 wherein the lift assist mechanism is a hydraulic cylinder.

4. The trailer of claim 1 wherein the power assist mechanism is a hydraulic motor.

5. The trailer of claim 1 further comprising a winch combined with the load carrying bed for assisting in loading and unloading objects from the trailer.

6. The trailer of claim 1 further comprising a winch combined with the trailer front portion for assisting in loading and unloading objects from the trailer.

7. The trailer of claim 1 further comprising a main deck transfer roller for supporting some of the weight of the load carrying bed as the wheel assembly is moved along the length of the rack.

8. The trailer of claim 2 further comprising an upper deck retainer roller to help keep the wheel assembly from becoming detached from the load carrying bed when the wheel assembly is elevated off of the ground as the lift assist mechanism moves the load carrying bed.

9. The trailer of claim 1 further comprising a rear bumper to help prevent the wheel assembly from becoming disengaged from the rack.

10. The trailer of claim 1 further comprising landing gear combined with the trailer front portion to help support the weight of the trailer.

11. The trailer of claim 1 further comprising landing gear combined with the load carrying bed to help support the weight of the trailer.

12. The trailer of claim 1 wherein the rack extends from the rear of the load carrying bed to the front of the load carrying bed.

13. The trailer of claim 1 wherein the trailer front portion further comprises a hitch adapted for attachment to a prime mover vehicle.

14. The trailer of claim 13 wherein the hitch is pivotally combined with the trailer front portion to allow the trailer front portion to be elevated without disturbing the trailer's connection to the prime mover vehicle.

15. A trailer comprising:
a front portion;
a load carrying bed pivotally combined with the front portion;
a wheel assembly combined with the underside of the load carrying bed;
a rack combined with the load carrying bed;
a pinion combined with the wheel assembly and adapted to engage the rack;
a power assist mechanism combined with the wheel assembly and adapted to engage and rotate the pinion, wherein activation of the power assist mechanism rotates the pinion and moves the wheel assembly along the rack;
a lift assist mechanism having a first end combined with the trailer front portion and a second end combined with the load carrying bed, wherein actuation of the lift assist mechanism pivots the front portion relative to the load carrying bed.

16. A trailer comprising:
a front portion;
a load carrying bed pivotally combined with the front portion;
a wheel assembly combined with the underside of the load carrying bed; and
a means for moving the wheel assembly relative to the load carrying bed.

17. The trailer of claim 16 wherein the means for moving the wheel assembly is a rack and pinion assembly.

18. The trailer of claim 16 further comprising a lift assist means for pivoting the front portion relative to the load carrying bed.
The trailer of claim 18 wherein the lift assist means is a hydraulic cylinder.
